(19) United States
(12) Patent Application Publication
(10) Pub. No.: US 2005/0047499 A1
(43) Pub. Date: Mar. 3, 2005

(54) System and method for measuring the response time of a differential signal pair squelch detection circuit

(76) Inventor: Glenn Wood, Colorado Springs, CO (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/651,741

(22) Filed: Aug. 29, 2003

(51) Int. Cl. H04B 17/00

(52) U.S. Cl. 375/224

(57) ABSTRACT

A system and method for measuring the response time of a differential signal pair squelch detection circuit is provided. First, both the positive and negative signal lines of the differential signal pair are driven with square waves of different frequencies, typically by way of a signal generator. Thereafter, either the phase or the frequency of the two square waves is gradually altered until the duty cycle of a squelch detect signal of the squelch detection circuit falls below fifty percent. The resulting period of the square waves, or the relative phase between the two, is then utilized to calculate the response time of the squelch detection circuit.

### BACKGROUND OF THE INVENTION

Several modern high-speed serial data busses, normally used for digital communication between physically separated electronic devices, implement the well-known, time-tested “differential pair” signal line configuration to transmit and receive data. The differential pair typically consists of two signal lines, a positive (“p”) signal line and a negative (“n”) signal line, which normally exhibit one of two possible voltage values during data transmission. During such data transmission, the two signal lines exhibit different voltage values from each other. For example, a data value of ‘1’ is usually indicated on a differential pair with a voltage V+ on the “p” line, and a lower voltage V− on the “n” line. Similarly, to indicate a data value of ‘0’, the “p” line holds a voltage of V− while the “n” line exhibits a voltage of V+. Therefore, except during times in which the data value of the differential pair is in transition, the magnitude of the differential voltage between the two signal wires generally remains at about V+minus V−. Advantageously, differential pair signal lines have long been known to demonstrate high common-mode rejection, which allows the data being transferred to be unaffected by noise that is induced onto both signal wires of the differential pair.

In addition to transferring data, the modern serial data busses that utilize differential pairs for data transfer, such as Serial AT Attachment (Serial ATA), also utilize those same signal wires to indicate changes in the overall state of the communication link, such as to invoke data bus power management. To indicate these state changes, the two signal wires of the differential pair normally are driven so that the resulting differential voltage is substantially zero for specific periods of time. Driving the differential signal pair in this manner is commonly known as “squelch,” or “out-of-band” signaling. As a result, electronic devices connected to such a bus are usually required to generate and detect the squelch state of the differential pair, which generally lasts only for a few tens or hundreds of nanoseconds.

Testing the operation of a squelch detection circuit is a crucial task in the design and manufacturing of such a circuit to ensure proper operation of the circuit under various circumstances. For example, an important trait of the detection circuit to be tested is its squelch “noise floor,” which is the circuit's sensitivity to noise when the voltage across the differential signal pair is near the maximum allowed to indicate the squelch state.

One particularly important characteristic requiring testing is the time the detection circuit requires to detect the squelch state. The measuring of this characteristic is especially important in view of the fact that various filtering techniques likely to be employed to improve the noise floor of the circuit also have a deleterious effect on the dynamic response of the circuit. Given that a squelch state may only last a few tens or hundreds of nanoseconds, as mentioned above, any significant delay in detecting the squelch state is likely to allow some of these states to avoid detection altogether. Unfortunately, specialized test equipment that is capable of measuring this response time is not currently available.

Therefore, a need presently exists for a reliable method for measuring the response time of a squelch detection circuit for a differential signal pair using a test system consisting of general-purpose test equipment. Ideally, such a method that elicits the response time of a squelch detection circuit would be simple in implementation, short in execution, and capable of being implemented using standard automated test equipment in the manufacturing environment.

### SUMMARY OF THE INVENTION

Embodiments of the invention, to be discussed in detail below, provide a method for measuring the response time of a differential signal pair squelch detection circuit. First, both the positive and negative signal lines of the differential signal pair are driven with square waves. One of the signal lines is driven by a first square wave having a period twice the duration of a squelch state that is easily detectable by the squelch detection circuit. The remaining signal line is driven by a second square wave with a period that is an integral multiple of the period of the first square wave, with the period of the second square wave being at least four times the period of the first square wave. Also, the second square wave is maintained in phase with the first square wave. The period of both the first and second squares waves is then gradually reduced by the same percentage until the duty cycle of a squelch detect signal of the squelch detection circuit is less than fifty percent. The response time of the squelch detection circuit is then represented by half of the resulting period of the first square wave.

In an alternate embodiment, the first square wave driving one of the differential signal lines has a period four times the duration of a squelch state that is essentially always detectable by the squelch detection circuit. Like before, the second square wave driving the remaining signal line has a period that is an integral multiple of the first square wave period, with the period of the second square wave being at least four times that of the first square wave. Initially, the second square wave lags the first square wave by ninety degrees. The phase lag of the second square wave compared to the first is then gradually increased until the duty cycle of the squelch detect signal is less than fifty percent. As a result, the squelch detection circuit response time is 180 degrees minus the resulting phase lag of the second square wave, divided by 360 degrees, multiplied by the period of the first square wave.

Use of the embodiments of the invention result in a simple and accurate determination of the response time of a squelch detection circuit with the use of standard electronic test equipment. Also, the overall testing time of a particular squelch detection circuit is minimal, and automated test equipment may be used to implement the embodiments of the present invention for the manufacturing environment.

Other aspects and advantages of the invention will become apparent from the following detailed description, taken in conjunction with the accompanying drawings, illustrating by way of example the principles of the invention.

### BRIEF DESCRIPTION OF THE DRAWINGS

FIG. 1 is a waveform diagram describing the operation of a differential signal pair when transferring data and when in a squelch state.

FIG. 2 is a block diagram of a possible system for testing a squelch detection circuit implementing the method embodiments of the invention.

FIG. 3 is a flow chart describing a method of measuring the response time of a squelch detection circuit according to a first embodiment of the invention.

FIG. 4 is an idealized waveform diagram of the initial test signals of the method of FIG. 3 that drive the positive and negative signal lines of a differential pair, and the resulting squelch detect signal generated by a squelch detection circuit under test.

FIG. 5 is an idealized waveform diagram of the resulting test signals of the method of FIG. 3 that drive the positive and negative signal lines of a differential pair, and the resulting squelch detect signal generated by the squelch detection circuit under test.

FIG. 6 is a flow chart describing a method of measuring the response time of a squelch detection circuit according to a second embodiment of the invention.

FIG. 7 is an idealized waveform diagram of the initial test signals of the method of FIG. 6 that drive the positive and negative signal lines of a differential pair, and the resulting squelch detect signal generated by a squelch detection circuit under test.

FIG. 8 is an idealized waveform diagram of the resulting test signals of the method of FIG. 6 that drive the positive and negative signal lines of a differential pair, and the resulting squelch detect signal generated by the squelch detection circuit under test.

### DETAILED DESCRIPTION OF THE PREFERRED EMBODIMENTS

Before describing specific embodiments of the invention, a short discussion of the actions of the differential signal lines, “p” and “n”, during both the data transfer state and squelch, or out-of-band, state is desirable. As stated earlier, the squelch state essentially is the state in which the “p” and “n” signal lines are not being driven to their normal data transmission voltage levels.

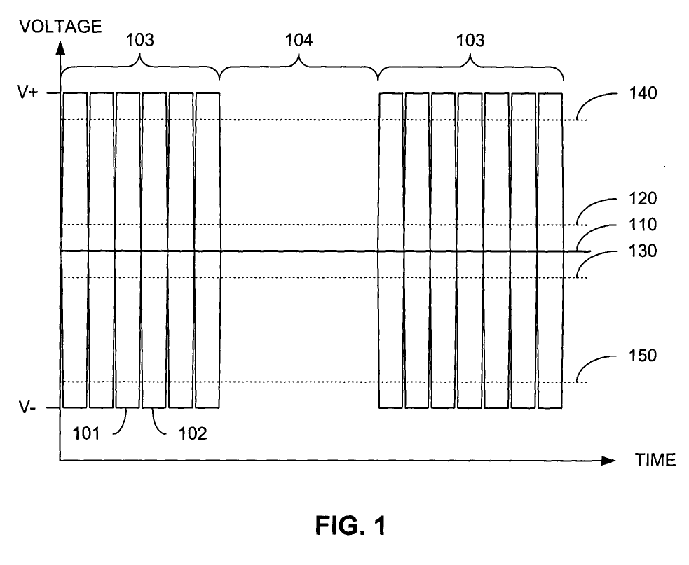

FIG. 1 displays in an idealized fashion the action of the differential signal lines when in a data transfer state 103 and while in a squelch state 104. In typical differential signal fashion, the “p” signal waveform 101 and the “n” signal waveform 102, during the data transfer state 103, are essentially mirror images of each other across a midpoint voltage 110, existing substantially halfway between voltage levels V+ and V−. In other words, while the voltage of the “p” signal waveform 101 is at V+, the voltage of the “n” signal waveform 102 is at V-, and vice-versa. To ensure that the data represented by the “n” and “p” signal lines is interpreted properly, the signal waveforms 101 and 102 must reside above a minimum high data voltage 140 or below a maximum low data voltage 150 for data to be transmitted reliably. In meeting this requirement, data is transmitted reliably across the differential signal lines when the difference between the differential pair exceeds the difference between the minimum high data voltage 140 and the maximum low data voltage 150. These data thresholds are normally specified to allow for variations in signal driver and receiver designs, noise from other signal sources, and other factors to ensure interoperability across devices transmitting and receiving data via the differential pair.

During the squelch state 104, the “p” and “n” signals generally maintain their voltage within a second pair of voltage limits so that the squelch state 104 can be distinguished from the data transfer state 103. More specifically, the differential signals should maintain their voltage levels between the maximum squelch voltage 120 and the minimum squelch voltage 130 to ensure that the squelch state 104 will be detected. In doing so, the difference between the voltages of the differential signal pair is less than the difference between the maximum squelch voltage 120 and the minimum squelch voltage 130, thus indicating the squelch state 104.

In response to the initiation of the squelch state 104, a squelch detection circuit, upon detecting the presence of that state, typically forces a squelch state signal to its active state. However, when the duration of the squelch state 104 is sufficiently short, it will not be detected by the squelch detection circuit. This duration is referred to as the circuit's response time. As described earlier, the response time is a critical characteristic of a squelch detection circuit, and measuring that characteristic is the focus of the various embodiments of the present invention.

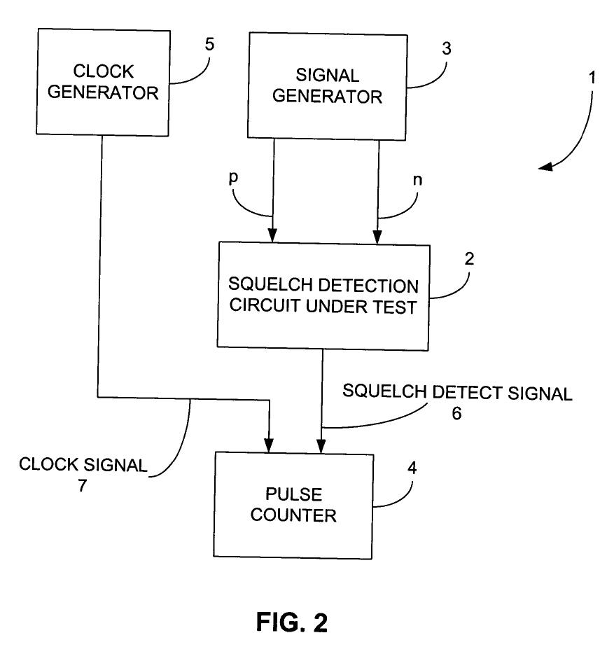

To facilitate the measuring methods disclosed herein, a test system 1, shown in FIG. 2, consisting of general-purpose test equipment, may be employed. In the disclosed embodiments, a signal generator 3, such as a waveform or pulse generator, generates a square wave on each of the positive (“p”) and negative (“n”) signal lines of the differential pair to which the squelch detection circuit under test 2 is connected. The frequencies of the two square waves are different to facilitate testing of the squelch detection circuit response time. The higher frequency square wave may be used to drive either the positive or negative signal line. Squelch states exist on the differential signal pair when the two square waves, essentially swinging between V+ and V−, are either both at a logic HIGH (i.e., at V+) or a logic LOW (at V−) simultaneously.

The output signal of the squelch detection circuit, the squelch detect signal 6, drives an input of a pulse counter 4. Also, a clock generator 5 produces a clock signal 7 that drives a separate input of the pulse counter 4 so that the number of pulses of the clock signal 7 that occur while the squelch detect signal 6 is active, as well as the total number of pulses of the clock signal 7 occurring over the same time period, may be counted. As a result of this comparison, the response time of the squelch detection circuit 2 may be determined.

Under the initial conditions of the first and second square waves, as described below, the squelch detection circuit 2 is able to detect all squelch states appearing on the positive and negative signal lines of the differential pair. Under those circumstances, the squelch detect signal 6 essentially exhibits a 50% duty cycle, as determined by the operation of the pulse counter 4. For example, assume the clock signal 7 operates at a frequency several times that of the first and second square waves. Also assume that the pulse counter 4 counts both “raw” pulses of the clock signal 7 and “enabled” clock signal 7 pulses that occur while the squelch detect signal 6 is active over multiple cycles of the second square wave. Under these conditions, the pulse counter 4 will count half as many “enabled” clock signal 7 pulses as there are “raw” clock signal 7 pulses, due to the 50% duty cycle. However, as will be seen below, changes in frequency or phase of the first and second square waves can lower the ratio of enabled-to-raw clock signal 7 pulses, thus indicating a change in duty cycle of the squelch detect signal 6. As a result of this change in duty cycle, the response time of the squelch detection circuit 2 may then be calculated, as discussed in detail below. Generally speaking, the frequency of the clock signal 7 should be at least several times the frequency of the first square wave, with a frequency of 200 times that of the first square wave being viewed as adequate for most applications. Similarly, the length of time the pulse counter 4 operates for each measurement should be an integral number of periods of the second square wave to ensure a 50% duty cycle initially, with a factor of 16 typically being considered sufficient in most cases.

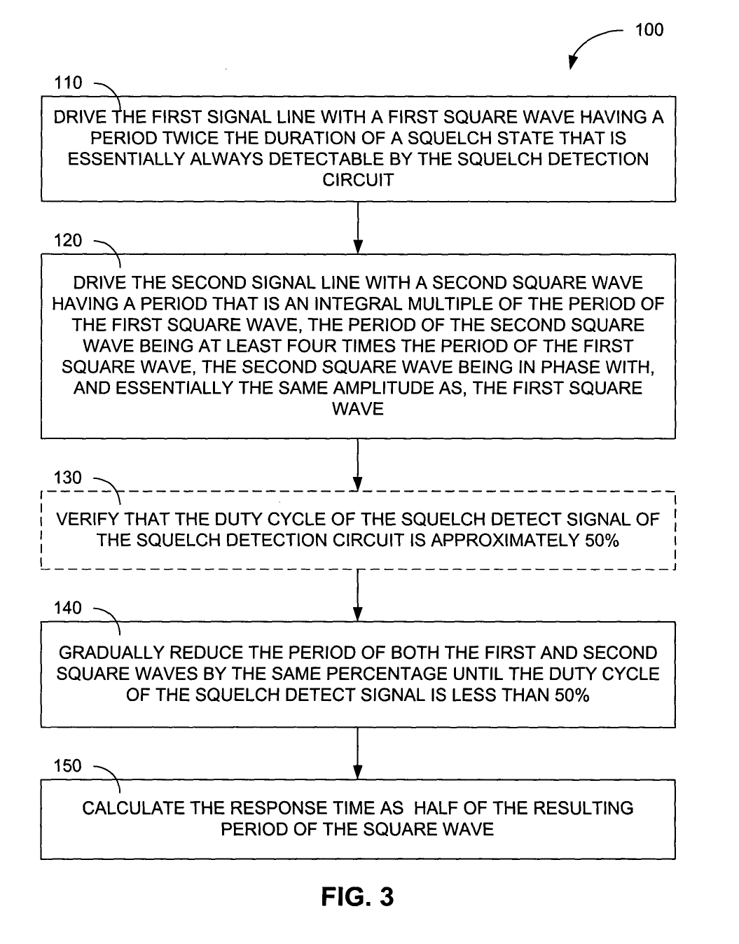

In a first method embodiment 100 of FIG. 3, a first signal line, which may be either the positive or negative signal line, is driven with a first square wave having a period T that is twice the duration of a squelch state that is practically always detectable by the squelch detection circuit under test (step 110). A second square wave having a period that is an integral multiple of the period of the first square wave of at least 4T, in phase with and of the same amplitude as the first square wave, drives the remaining signal line (step 120).

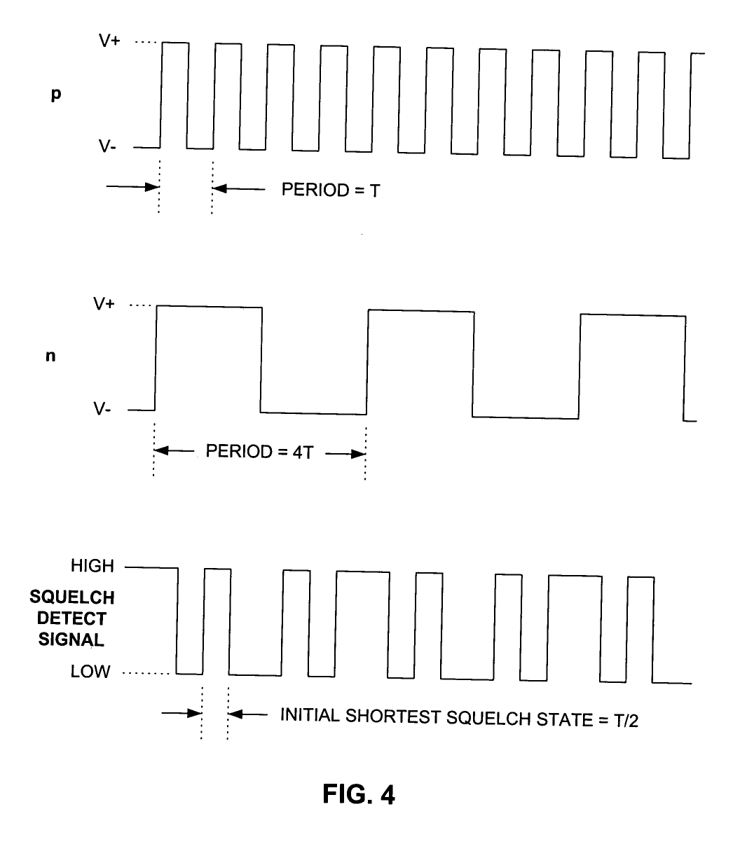

A specific example of the initial driving conditions of the method 100 is shown in FIG. 4. In this case, the positive (“p”) signal line is driven by the first square wave mentioned above. The second square wave of period 4T, which is in phase with the first square wave, drives the negative (“n”) signal line. The first and second square waves also have essentially the same amplitude so that a squelch state will be detected during times when both waves are at V+ or V−. As noted above, which square wave drives which of the two signal lines is unimportant, so the first square wave could just as easily be applied to the negative signal line, and the second square wave to the positive signal line, in alternate embodiments.

Under these initial conditions, the resulting squelch detect signal, as shown in FIG. 4, produces squelch states that are of duration T/2 at their shortest. Squelch states of such a duration should practically always be detected by the squelch is detection circuit, as mentioned above. However, optional verification of this fact may be beneficial (step 130 of FIG. 3). This verification is performed by ensuring that the duty cycle of the squelch detect signal of the squelch detection circuit is approximately 50%, as described above. In other words, the squelch detect signal is active half of the time under these initial conditions.

Thereafter, the period of both the first and second square waves is gradually reduced by the same percentage until the duty cycle of the squelch detect signal drops below the 50% level (step 140). At that point, the squelch detection circuit is operating at the edge of its response time capabilities. As a result, the response time of the circuit may be calculated by taking half of the resulting period of the first square wave, which represents the minimum length of the squelch state that the squelch detection circuit is able to detect (step 150):
Response time=T_{final}/2

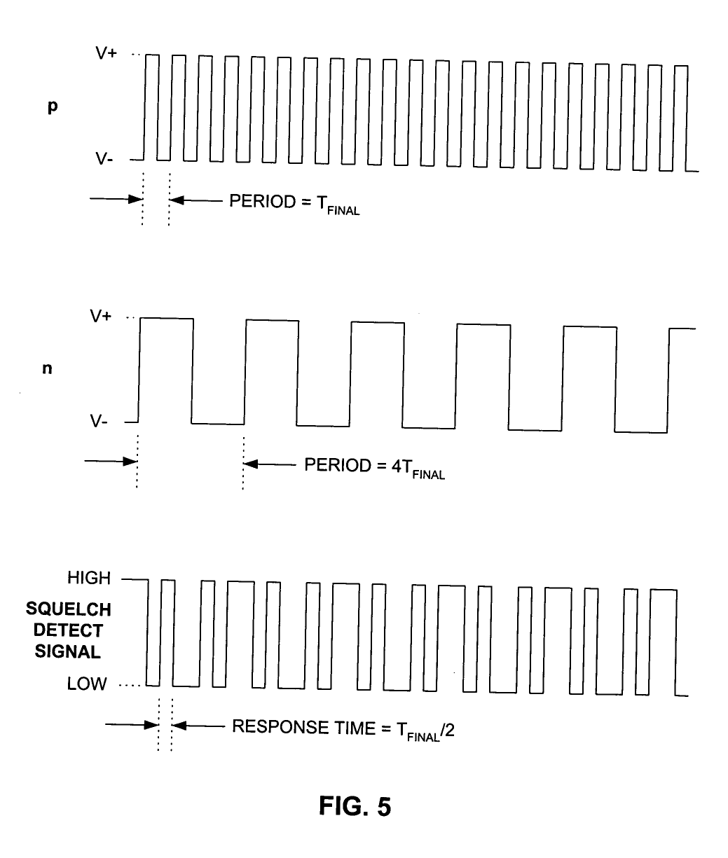

FIG. 5 shows an idealized set of waveforms of the first and second square wave signals resulting from the method embodiment 100 just as the squelch detect signal duty cycle begins to fall below the fifty-percent level. At that point, the shortest length of the squelch states presented over the positive and negative signal lines is half of the final period of the first square wave, or T_{final}/2, representing the minimum response time of the squelch detection circuit under test.

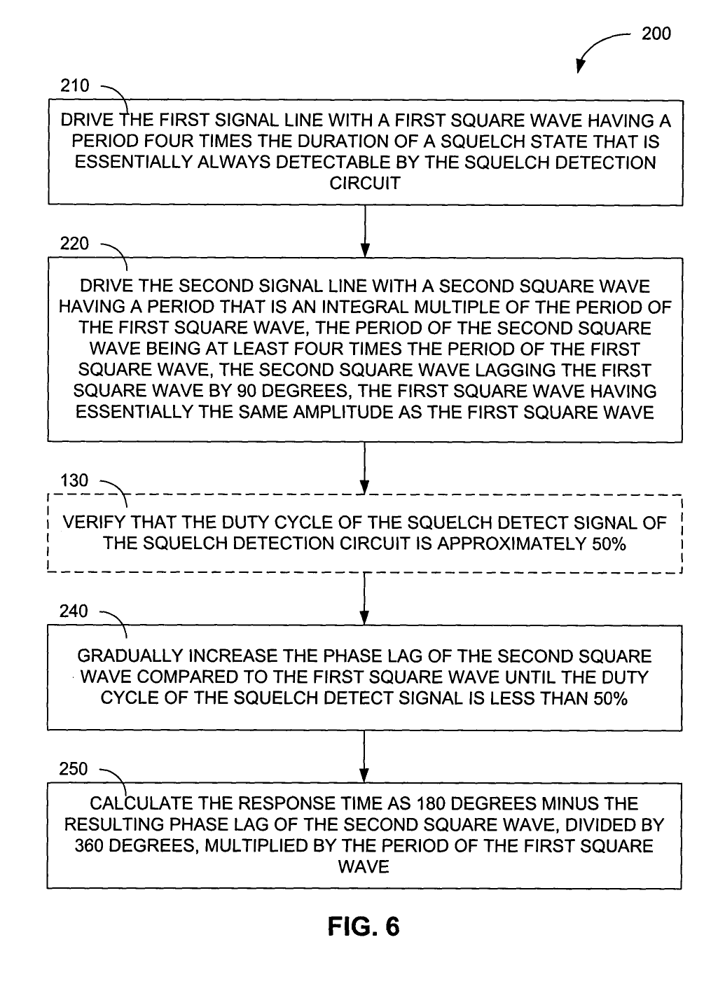

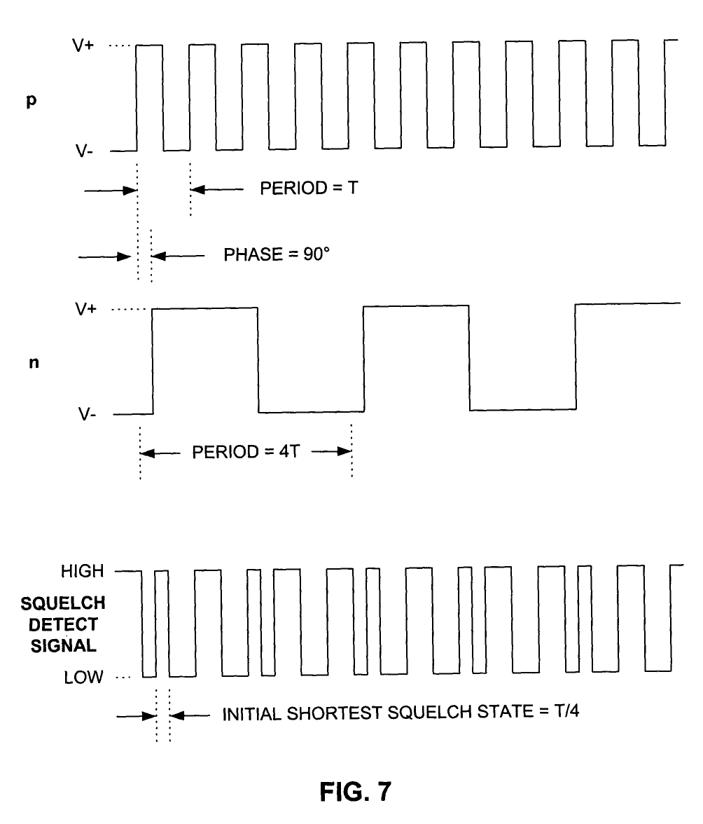

Another embodiment 200, as shown in FIG. 6, employs a similar method, but utilizes changes in phase instead of frequency to determine the response time. In this case, the first signal line is driven by a first square wave that has a period four times the duration of a squelch state that is essentially always detectable by the squelch detection circuit (step 210). As before, a second square wave having a period of an integral multiple of at least four of the period of the first square wave drives the second signal line (step 220). Also, the second square wave has the same amplitude as the first square wave, but lags the first square wave by ninety degrees. FIG. 7 displays a particular example of these initial driving conditions of the differential signal pair, with the first square wave of period T driving the positive signal line, and the second square wave of period 4T driving the negative signal line. The squelch detect signal that results from these initial conditions produces squelch states that are of duration T/4 at their shortest, in accordance with the requirements that T be four times as long as a squelch state that is practically always detectable.

Optionally, verification that the duty cycle of the squelch detect signal generated by the squelch detection circuit is about fifty percent may be undertaken, as before (step 130 of FIG. 6). Such a step essentially guarantees that the initial period selected for the first square wave is long enough to ensure that practically all squelch states are detected prior to altering the phase between the first and second square waves.

To determine the response time of the circuit, the phase lag of the second square wave compared to the first is then gradually increased until the squelch detect signal duty cycle falls below its initial 50% value (step 240). Accomplishing this step allows the calculation of the response time as 180 degrees minus the resulting or final phase lag of the second square wave, divided by 360 degrees, multiplied by the period T of the first square wave (step 250):
Response time=((180°Φ_{final})/360°)*T

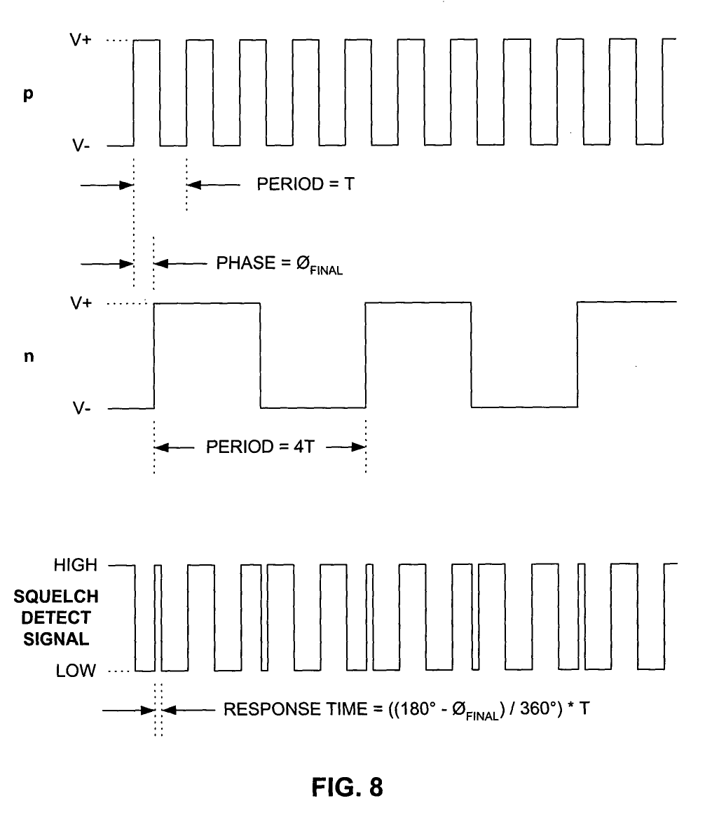

FIG. 8 shows an idealized set of waveforms of the first and second square waves resulting from the method embodiment 200 just as the duty cycle of the squelch detect signal begins to drop below the 50% level. At that point, the length of the shortest squelch states presented over the signal lines is half of the period of the first square wave in degrees, minus the final phase lag of the second square wave. This angular value is then divided by a full 360 degrees and multiplied by a full period of the first square wave to convert to a time value, thus representing the minimum response time of the squelch detection circuit under test.

The disclosed embodiments of the invention are appropriate primarily for testing squelch detection circuits that are insensitive to the direct-current (DC) value of the common mode voltage. The methods described produce the squelch state by driving both lines of the differential signal pair to either V+ or V−, as opposed to the midpoint voltage 110 typically seen in actual squelch operation. As a result, the methods disclosed herein are not applicable if the squelch detection circuit is designed to only detect squelch via the voltage of one or both of the differential signal lines residing between the maximum squelch voltage 120 and the minimum squelch voltage 130, as displayed in FIG. 1.

From the foregoing, embodiments of the invention provide a simple and reliable system and method for measuring the response time of a squelch or out-of-band detection circuit for a differential signal pair. Specific embodiments of the invention other than those shown above are also possible. As a result, the invention is not to be restricted to the specific forms so described and illustrated; the invention is limited only by the claims.

1. A test system for measuring the response time of a squelch detection circuit configured to detect a squelch state over a differential signal pair, the differential signal pair having a first signal line and a second signal line, the test system comprising:
a signal generator configured to drive a first square wave onto the first signal line and a second square wave onto the second signal line, the frequency of the first signal line being higher than the frequency of the second signal line, the amplitudes of the first and second square waves being essentially equal;
a clock generator configured to produce a clock signal of a higher frequency than the first square wave; and
a pulse counter configured to count the number of pulses of the clock signal, and the number of pulses of the clock signal that occur while a squelch detect signal of the squelch detection circuit is active.

2. The test system of claim 1, wherein the frequencies of the first square wave and the second square wave may be varied.

3. The test system of claim 1, wherein the phase between the first square wave and the second square wave may be varied.

4. The test system of claim 1, wherein the signal generator is a waveform generator.

5. The test system of claim 1, wherein the signal generator is a pulse generator.

6. A method for measuring the response time of a squelch detection circuit configured to detect a squelch state over a differential signal pair, the differential signal pair having a first signal line and a second signal line, the method comprising:
driving the first signal line with a first square wave having a period twice the duration of a squelch state that is essentially always detectable by the squelch detection circuit;
driving the second signal line with a second square wave having a period that is an integral multiple of the period of the first square wave, the period of the second square wave being at least four times the period of the first square wave, the second square wave being in phase with, and having essentially the same amplitude as, the first square wave;
gradually reducing the period of both the first and second square waves by the same percentage until the duty cycle of a squelch detect signal of the squelch detection circuit is less than fifty percent, resulting in a final period of the first square wave; and
calculating the response time of the squelch detection circuit as half of the final period of the first square wave.

7. The method of claim 6, further comprising verifying that the duty cycle of the squelch detect signal of the squelch detection circuit is approximately fifty percent prior to the gradually reducing step.

8. The method of claim 6, wherein the first square wave and the second square wave are generated by a signal generator.

9. The method of claim 6, wherein the number of pulses of a clock signal, and the number of pulses of the clock signal that occur while the squelch detect signal of the squelch detection circuit is active, are counted by a pulse counter to determine the duty cycle of the squelch detect signal.

10. The method of claim 9, wherein the number of pulses of the clock signal that occur during a cycle of the first square wave is at least 200.

11. The method of claim 9, wherein the duty cycle of the squelch detect signal of the squelch detection circuit is measured by the pulse counter over at least 16 cycles of the second square wave.

12. A method for measuring the response time of a squelch detection circuit configured to detect a squelch state over a differential signal pair, the differential signal pair having a first signal line and a second signal line, the method comprising:
driving the first signal line with a first square wave having a period four times the duration of a squelch state that is essentially always detectable by the squelch detection circuit;
driving the second signal line with a second square wave having a period that is an integral multiple of the period of the first square wave, the period of the second square wave being at least four times the period of the first square wave, the second square wave lagging the first square wave by ninety degrees, the second square wave having essentially the same amplitude as the first square wave;
gradually increasing the phase lag of the second square wave compared to the first square wave until the duty cycle of a squelch detect signal of the squelch detection circuit is less than fifty percent, resulting in a final phase lag of the second square wave; and
calculating the response time of the squelch detection circuit as 180 degrees minus the final phase lag of the second square wave, divided by 360 degrees, multiplied by the period of the first square wave.

13. The method of claim 12, further comprising verifying that the duty cycle of the squelch detect signal of the squelch detection circuit is approximately fifty percent prior to the gradually increasing step.

14. The method of claim 12, wherein the first square wave and the second square wave are generated by a signal generator.

15. The method of claim 12, wherein the number of pulses of a clock signal, and the number of pulses of the clock signal that occur while the squelch detect signal of the squelch detection circuit is active, are counted by a pulse counter to determine the duty cycle of the squelch detect signal.

16. The method of claim 15, wherein the number of pulses of the clock signal that occur during a cycle of the first square wave is at least 200.

17. The method of claim 15, wherein the duty cycle of the squelch detect signal of the squelch detection circuit is measured by the pulse counter over at least 16 cycles of the second square wave.
